(19) United States
(12) Patent Application Publication
(10) Pub. No.: US 2012/0049410 A1
(43) Pub. Date: Mar. 1, 2012

(54) Apparatus and process for making soft gel capsules

(76) Inventors: Carlos Salazar Altamar, Barranquilla (CO); Orlando Torres, Barranquilla (CO); Braulio Teran, Barranquilla (CO); Gustavo Anaya, Soledad (CO); Newman Aguas Navarro, Barranquilla (CO); Willmer Herrera, Barranquilla (CO)

(21) Appl. No.: 13/137,046

(22) Filed: Jul. 18, 2011

Related U.S. Application Data
(60) Provisional application No. 61/344,418, filed on Jul. 19, 2010.

(51) Int. Cl. B28B 3/12; B29C 53/00

(52) U.S. Cl. 264/294; 425/317

(57) ABSTRACT

An apparatus for making softgel capsules comprising: two extrusion nozzles; two cooling and tension rollers; two rotary dies; a wedge; and a filling station. A method is also provided for for producing softgel capsules, comprising the steps of: (a) softening or melting a suitable film forming composition; (b) extruding said suitable film forming composition through two extrusion dies directly into two tension rollers; (c) passing the extruded films over rotating dies; (d) simultaneously forming, filling, heat-sealing and cutting capsules; and (e) washing and drying said capsules.

This application claims the priority benefit under 35 U.S.C. section 119 of U.S. Provisional Patent Application No. 61/344,418 entitled “Improved Apparatus And Process For Making Soft Gel Capsules” filed Jul. 19, 2010, which is in its entirety herein incorporated by reference.

### FIELD OF THE INVENTION

This invention relates to methods and apparatus for the production of soft gelatin capsules containing medicinal compounds. Such capsules are now well established as a means for providing a variety of liquid products such as drugs and dietary supplements in a readily ingestible form.

This invention further relates to softgels (or soft gelatin capsules) and to a process and apparatus for the manufacture thereof. The present invention also relates to a gelatin capsule of the soft type containing medicine or the like, and more particularly to a novel gelatin capsule capable of containing medicinal or dietary supplement as the content, and its manufacturing method and manufacturing apparatus.

The present invention also relates generally to a method and apparatus for forming capsules containing a measured amount of medicinals and more particularly to a method and apparatus for forming capsules from extruded webs or sheets of capsule forming material, such as gelatin, as well as to various features of such method and apparatus, including an apparatus for forming webs for use in such capsule making method and apparatus. The method and apparatus of the present invention are particularly useful in connection with forming softgel capsules containing a pharmaceutical product, such as for example medicines, vitamins, food supplements and the like.

The present invention further relates to encapsulation machines and, more particularly, to soft encapsulation machines which make soft gelatin and non-gelatin capsules which utilize a extrusion mold.

The instant invention is an improvement upon the conventional rotary die process of making softgel capsules wherein the gelatin film is formed via extrusion dies or mold and avoids the use of spreader boxes and casting drums.

### BACKGROUND OF THE INVENTION AND DESCRIPTION OF THE PRIOR ART

The art of encapsulation has been known for many years, particularly for the production of unit dosage forms containing various pharmaceutical products. Normally, such pharmaceutical capsules are composed of gelatin or some modification thereof, which is fabricated essentially into two different forms, namely, the so-called hard gelatin capsule and the soft gelatin capsule.

It is also known that conventional soft gelatin capsules are a preferred from of administration for medicaments and similar products; especially liquids, pastes, solids dispersed in liquids, or dry solids. Soft gelatin capsules also possess particular advantages for substances which require total protection from air and light, because the gelatin is completely sealed around the contents. An important example is for the encapsulation of vitamins, which has resulted in a high degree of stability thereof.

Hard gelatin capsules are also known in the art, and are generally formed from two distinct parts, namely the “cap” and the “body”, fitting one into the other so as to form the complete capsule. The cap and the body are manufactured by the same process consisting of immersing in a gelatin solution the end of a mandrel whose form corresponds to the inner volume of the cap or of the body, then withdrawing the mandrel from the solution and letting the layer of gelatin thus deposited dry, which is then removed like a glove finger. Hard shell capsules so formed have problems of leakage and do not provide adequate protection from air and light

Soft gelatin capsules, now more commonly known as softgels, have been well known and widely used for many years. Softgels generally comprise an outer shell primarily made of gelatin, a plasticizer, and water, and a fill contained within the shell. The fill may be selected from any of a wide variety of substances that are compatible with the gelatin shell. Softgels are widely used in the pharmaceutical industry as an oral dosage form containing many different types of pharmaceutical and vitamin products. In addition to use as an oral dosage form for drugs and vitamins, soft gelatin capsules or softgels are also designed for use as suppositories for rectal or vaginal use. Other uses are for topical and ophthalmic preparations and the like. The cosmetic industry also uses softgels as a specialized package for various types of perfumes, oils, shampoos, skin creams and the like. Softgels are available in a great variety of sizes and shapes, including round shapes, oval shapes, oblong shapes, tube shapes and other special types of shapes such as stars. The finished capsules or softgels can be made in a variety of colors. Also, opacifiers may be added to the shell.

The process for making softgel capsules includes the step wherein the gelatin shell and the fill material come together to form Softgel capsules. It takes place in a closed environment called clean room where the relative humidity is around 20%. The gelatin shell and fill material are brought together simultaneously in the encapsulation machine.

The process is basically performed as follows: a pump delivers the warm gelatin over two chilled drums which are located at both opposite sides of the machine, through a spreader box that sits over each drum. The warm liquid gelatin flows over the drums and this transforms the liquid gelatin into two solid ribbons of gel. The left and right ribbons pass over rollers which feed them through two die rolls. These die rolls determine the shape and size of softgels and cut the Softgel shell from the ribbons as they turn around.

Simultaneously, a sensitive and high accuracy positive displacement pump delivers the fill material into a heated wedge which sits between rotary dies. This wedge injects the fill material into the die cavities between ribbons just right before the die rolls cut the ribbons and seal the two halves together. Warm just formed softgels slide gently through a chute onto a conveyor belt which carries them to the tumble dryer where cooling and drying process takes place.

In more specific detail, typical soft encapsulation machines form at least two flexible gelatin sheets or ribbons by cooling molten gelatin on separate drums then lubricating and guiding the sheets into communication with each other over co-acting dies while simultaneously dispensing a desired quantity of fill material between the sheets in synch with cavities in the outer surfaces of the dies to produce soft capsules. The encapsulation machines typically utilize gearing to control the relative rotations of the various components and fill mechanisms to synchronize the operation of these various components. The synchronization of these various components, however, can vary depending upon a variety of factors, such as the particular dies used, the number of cavities and the size of the cavities on the dies, and the type of material used to form the sheets. To change the synchronization of the various components, mechanical gears are required to be changed to obtain the desired ratios and synchronization of these components. The changing of gears, however, is time intensive. Additionally, the use of mechanical gears provides finite gear ratios which limit the synchronization of the various components to the mechanical gears that are available. Thus, it would be advantageous to provide a capsule machine wherein the synchronization and rates at which the various components operate can be altered without the necessity of changing gears. Additionally, it would be advantageous if the synchronization between the various components can be infinite to thereby allow more precise synchronization between the various components. It would also be advantageous to allow various components, such as the fill mechanism, to be adjusted independently of the other components while the machine is running to allow for adjustments of the timing of fill material inserted into each of the soft capsules. It would also be advantageous to eliminate the use of casting drums in the making of softgel capsules.

During the operation of the capsule making machine, the contact between the adjacent dies can be adjusted by the operator of the capsule making machine. Typically, the operator is able to move one of the dies closer to the other die so that the pressure or force exerted on the sheets passing between the adjacent dies can be adjusted. Such adjustments, typically are mechanical adjustments made by fluid actuators, such as pneumatic cylinders. The operator is able to adjust the pneumatic pressure thereby altering the force the dies exert on one another and on the sheets. This adjustability allows an operator to customize the pressure to ensure that quality soft capsules are produced. However, the dies are susceptible to premature failure and/or wear when the pressure or force between the two dies is more than that required to produce acceptable soft capsules. Thus, it would be advantageous to monitor/record the pressure applied to the dies so that quality capsules are produced without inducing excessive wear or premature wear on the dies.

A material fill mechanism is used to supply the fill material that is encapsulated within the soft capsules. When the fill material is a liquid, such as a liquid medication or die for a paint ball capsule, the fill mechanism includes a plurality of positive displacement plunger-type pumps that are arranged in a housing above the dies. The plunger-type pumps are positioned on a yoke that moves linearly in a reciprocating motion to allow the plunger-type pump to fill with the liquid fill material on one stroke and subsequently discharge the liquid fill material on the other stroke. A valving arrangement between opposing pumps is utilized to control the discharge and filling of the pumps. The valve arrangement includes a sliding member that moves linearly back and forth in a direction generally perpendicular to the linear motion of the yoke. The discharge of the liquid fill material into the sheets as they are passing through the dies is coordinated with the operation of the dies to insure that the timing of the injection of the liquid fill material is synchronized with the cavities on the dies. Typically, this synchronization has been performed through the use of mechanical gears that link the timing of the stroke to the rotation of the dies. Thus, in order to adjust the synchronization a mechanical gear change is required which is time consuming. Additionally, the timing is limited to a finite number of gear ratios as determined by the gears that are available.

The sliding member of the valving mechanism requires lubrication. Typically, the lubrication is provided by a lubricating pump with its own separate drive. However, the use of a separate drive to operate the lubricating pump adds additional complexity and components to the capsule machine. Thus, it would be advantageous if a motion of the slide member and/or the yoke could be utilized to drive the lubrication pump.

The pumps are typically contained within a housing that is filled with a lubricating oil that is used to lubricate the sliding member. The pumps, however, can leak around their seals and contaminate the lubricating oil with the leaking fill material. Contamination of the oil requires a time consuming and possibly difficult clean up and can cause the lubricating oil to not perform as designed thereby increasing the wear on the sliding surfaces and decreasing the life span of the sliding surfaces. Thus, it would be advantageous to capture any fill material that leaks from the pumps and deter or prevent the liquid fill material from contaminating the lubricating oil within the pump housing.

The pumps are typically driven by a drive mechanism that is also located within the pump housing. Because the drive mechanism is located in the pump housing, it is possible for liquid fill material that leaks from the pumps to contaminate not only the lubrication oil but also the drive mechanism. When switching from one fill material to another, the pump and all of the components in the pump housing are required to be thoroughly cleaned to remove all contamination. The locating of the drive mechanism within the pump housing provides additional components that must also be cleaned when changing the fill material. Thus, it would be advantageous to separate the drive mechanism from the pump housing to reduce the components that are required to be cleaned when changing fill material.

The soft capsules produced by the encapsulation machine are transported from the encapsulation machine to a dryer to additionally dry the soft capsules and to make them into final form. The soft capsules are transported from the encapsulation machine to the dryer by a conveyor that extends along the front of the encapsulation machine. The conveyor can be contaminated by the fill material during operation of the encapsulation machine. When it is desired to switch the product being produced on the encapsulation machine, the conveyor must be removed from the encapsulation machine and cleaned to remove any contaminates thereon. The conveyor is driven by a motor that is attached to the conveyor. When it is necessary to remove the conveyor for cleaning, the motor must also be taken with the conveyor which makes it more difficult to remove and transport the conveyor and requires additional time to disconnect the motor from the encapsulation machine.

Additionally, the conventional process of producing gelatin films comprises mixing gelatin, plasticizers and water, and heating the mixture while stirring under vacuum. The gelatin and excipients are heated under vacuum with mixing until a molten homogenous mixture is produced that is referred to as a gelatin melt. This occurs at approximately 45-65° C. The molten system is drained into heated tanks that maintain the gelatin in a molten state during staging and casting of the films. Staging can be as long as two to three days. Before encapsulation, other additives such as colorants, preservatives, sweeteners, flavors, texture modifiers and the like may be blended into the gelatin melt.

In the conventional method, transfer of molten gelatin from a holding tank to the spreader box is achieved in one of two ways. A useful method is to suspend or mount the tank of molten gelatin above the encapsulation machine and allow the molten material to be fed via gravity through heated tubes into the reservoir of the spreader box. Another method used is to pump the molten gelatin via heated tubes from floor mounted gelatin staging tanks using either a peristaltic or lobe pump system. One disadvantage of the pump feed system is that the pump casing/components and in-line connections must be maintained above the melting point of the film-forming composition. If there are cold areas within the path, the material will freeze and prevent flow. In addition, both gravity and pump systems require a method of controlling flow to prevent overfilling of the spreader boxes.

The conventional process also requires maintaining the gelatin melt in a molten state from initial manufacture to just before encapsulation. Tanks used to feed the encapsulation machine require the entire tank to be maintained above the melt temperature of the film-forming composition. Prolonged maintenance of gelatin or other film-forming compositions in a molten state leads to degradation of the polymer, rendering the gelatin after prolonged staging, ineffective at fabricating capsules. Gelatin melts can be staged typically no longer than 96 hours before unacceptable degradation occurs.

Gelatin can be cooled and allowed to solidify within the staging tanks to prevent degradation if prolonged staging is necessary. However, the major drawback is that the entire tank contents have to be remelted. This requires 8 to 15 hours of gently heating the material to raise the temperature of the gelatin mass to the required 60° C. Rapid heating of the system leads to localized heating, which can cause degradation and charring of the composition. Therefore, when stopping the encapsulation machine, a decision has to be made to: (1) continue to heat the gelatin which subjects it to degradation; or (2) allow it to solidify. The solidification subsequently requires the remelting which is very time consuming and expensive. Often, the result of stopping the encapsulation machine is that the melt is discarded which represents a significant waste of resources. Thermal degradation is often exacerbated by the addition of additives and can significantly shorten the available staging time.

A further drawback of the traditional process and apparatus is that it requires relatively low viscosities of the film-forming compositions. Spreader boxes rely on viscosities sufficiently low to enable the material to flow from the exit slot. The use of doctor blades and a rotating cylinder will enable slightly higher viscosity materials to be cast into films, but there is still a limit of about 20,000 to 25,000 cps on these dispensing systems. The conventional equipment and methodology therefore precludes the use of high viscosity film-forming compositions. Most alternative polymer compositions for forming films have viscosities significantly higher than that of gelatin.

The present invention provides an encapsulation machine that overcomes the above-described disadvantages of typical encapsulation machines.

Applicant is aware of the following publications briefly discussed below. U.S. Pat. No. 1,970,396 features a method and machine for producing soft gelatin capsules in an automated process. The method involves the formation of two gelatin sheets or films through the use of a gravity fed spreader box, cooling the liquid gelatin on two separate webs, then lubricating and guiding the two sheets into communication with each other between two co-acting dies while simultaneously dispensing the proper amount of medicine or other filling material between the sheets in registration with half cavities in the outer surface of the dies.

U.S. Pat. No. 5,761,886 discloses an apparatus for forming capsules that provides rotary dies that are independently moveable and the ability to vary the speed of the dies during the formation of a single capsule. The '886 device also utilizes independently controlled casting drums to reduce “set-up” time and provide better quality control. Even though the '886 patent discloses a very sophisticated encapsulation machine, it still utilizes a gravity fed spreader box for formation of the encapsulating ribbon.

Other patents relating to encapsulation techniques which disclose the use of spreader boxes to create the film or ribbon on a casting drum include U.S. Pat. Nos. 2,288,327; 2,774,988; 5,246,638; 5,735,105; and 6,022,499.

### BRIEF DESCRIPTION OF THE FIGURES

FIG. 1 shows a front perspective view of the soft capsule manufacturing machine of the invention.

FIG. 2 shows a side view of the soft capsule manufacturing machine of the invention.

FIG. 3 is a more detailed view showing in more detail the extrusion box and tension and cooling rollers.

FIG. 4 shows an extrusion die according to the invention.

### SUMMARY OF THE INVENTION

The invention is an improved apparatus for preparing softgel capsules using the conventional rotary molding process wherein the improvement comprises providing two extrusion dies that provide a film directly into the cooled guide/tension rollers that guide the film directly into the rotary dies.

The instant invention provides an apparatus for making softgel capsules comprising: two extrusion nozzles; two cooling and tension rollers; two rotary dies; a wedge; and a filling station.

The invention also provides a process for producing softgel capsule, comprising the steps of: (a) softening or melting a suitable film forming composition; (b) extruding said suitable film forming composition through two extrusion dies directly into two cooled tension rollers; (c) passing the extruded films over rotating dies; (d) simultaneously forming, filling, heat-sealing and cutting capsules; and (e) washing and drying said capsules.

The instant invention further provides an apparatus for making softgel capsules comprising: (a) means for pumping and providing a fluid film forming substance directly into two extrusion nozzles, said extrusion nozzles directly located so upon extruding a film said film goes directly into two cooling and tension rollers for transportation of said film to two rotary dies; an injection wedge disposed between and in communication with said rotary dies; and a filling station.

The present invention also provides an apparatus for forming softgel capsules comprising: pumping means for supplying at least one flowable mass which is formable into a sheet configuration; extruding means for forming two sheets from said flowable mass; means for forming filled capsules with said sheets; means for transferring said sheets from said sheet forming means to said capsule forming means; said capsule forming means comprising two rotary dies; means for dispensing a filler substance to at least one portion of one of said sheets prior to said portion exiting said encapsulation region where said filler substance is encapsulated between portions of said sheets with the proviso that said apparatus does include spreader boxes or casting drums.

### DETAILED DESCRIPTION OF THE INVENTION

The prior art technology for the manufacture of softgel capsules using the rotary die process typically utilizes a spreader box system to cast the films or sheets onto the chilled surface of a casting drum. The present invention differs from the prior art technology in the method of producing the sheets or films. In the instant invention, extrusion dies are used as alternative to using spreader boxes and casting drums. Furthermore, the film forming composition is not kept molten but rather it is allowed to solidify and only the amount needed is softened or melted just prior to pumping it through an extruder box.

The instant invention differs from the conventional methods of making the film in the aspects of staging the film-forming composition and the method of producing the ribbon or film. The film-forming composition may be produced in a manner described in the prior art or using new compositions. In the present invention, the liquid, film-forming composition is placed within a container or a reservoir of and used on demand and allowed to solidify.

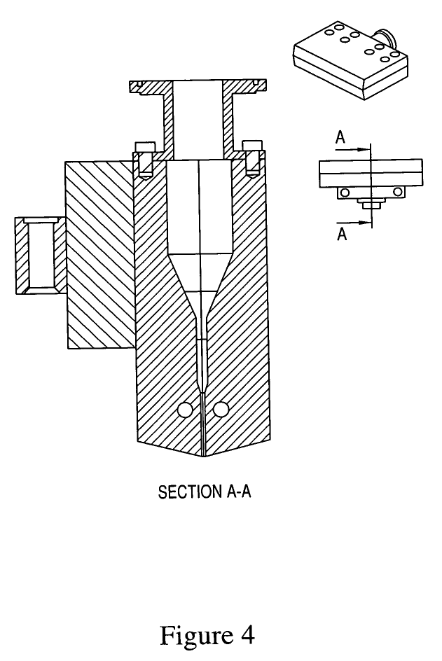

Additionally, the present invention is different from the conventional art in that the spreader box is replaced with an extrusion die (See FIG. 4). The die is different from a spreader box in that the film-forming composition is pumped under pressure through a slot under laminar flow. The uniform thickness of the ribbon is also achieved through a design of the extrusion die that provides for equal pressure distribution across the die opening. Further, the extrusion die is so designed internally that the rate of flow is substantially even across the exit slot of the die. The body of the extrusion die may optionally be heated a few degrees Celsius (i.e., 1-15° C.), above the melting point of the film-forming composition. Unlike the spreader boxes of the conventional processes, there is no reservoir of material and the ribbons or films are extruded under pressure.

Due to the ability of extrusion dies to produce films using pressurized film-forming material, the corresponding viscosities of the film-forming polymers may be significantly higher than the viscosity limits imposed by the conventional spreader box technology. Examples of films formed with viscosities at the casting temperature in the region of 70,000 to 130,000 cps have been produced.

The film-forming material or composition can be any material known in the art to be useful for encapsulation or enrobing technologies. Typically, these film-forming materials comprise at least one component selected from the group consisting of gelatin, starch, carrageenans, gums or synthetic materials such as hydroxypropylatedmethylcellulose (HPMC), other hydroxyalkylated celluloses and the like. The film-forming material typically has an aqueous base and is considered to be ingestible. As used herein, the term “ingestible” is used to indicate a film-forming material that dissolves under conditions simulating the human digestion tract or water.

The key feature of the present invention resides in the use of a use on demand reservoir or container in combination with a pump to supply an extrusion device that produces a film directly into a cooled guide and tension roller. The ribbons produced using the apparatus and process described herein are very uniform in thickness with very few defects.

It should be emphasized that the instant invention does not use spreader boxes or casting drums. The extruded film goes directly through a cooled roller and then directly into the rotary mold process as described.

The instant invention provides an apparatus for making softgel capsules comprising: two extrusion nozzles; two cooling and tension rollers; two rotary dies; a wedge; and a filling station.

The basic components (as shown in the figures) of the apparatus of the invention are: A recirculating water hose 1, a wedge segment 2, the gelatin film 3, a gel dispenser extruder 4, a pump for dispensing medicine 5, the rotary die (mold) 6, a cooling system 7, a pump housing 8, a housing 9, a medicine hopper 10, a mold holder 11, an unbreakable despendedor system 12, a tubing for the passage of medicine 13 and a clamp coupling 14.

The present invention is novel in that it lacks the conventional use of spreader boxes and casting drums in the manufacture of soft gelatin capsules.

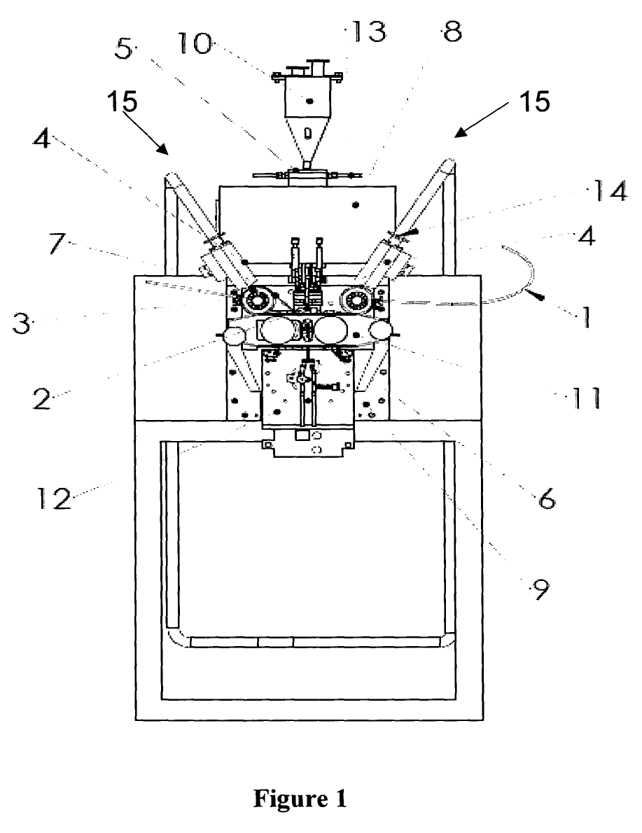

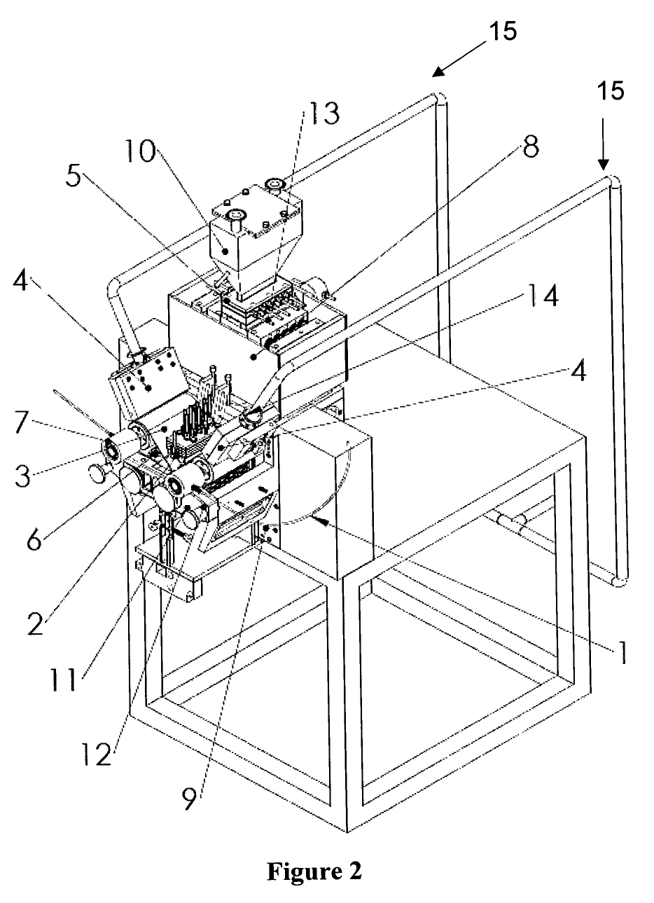

FIG. 1 shows a front perspective view of the soft capsule machine of the invention while FIG. 2 shows a side view of the soft capsule machine of the invention. In operation, the gelatin or other film forming composition housed in a tank or container (not shown) is softened or melted and pumped via tubing 15 and fed to the extrusion die or box 4 held in place by coupling clamp 14 and said die or box is placed directly above the tension and cooling guide rollers 7. The extruded film 3 then passes through a pair of tension and cooling guide rollers 7 which are cooled with chilled water passing through recirculating hose 1. The resulting extruded film 3 (second film from the other extruder box not shown) is then immediately fed into the rotary dies 6 for making the soft gel capsules of the invention.

As stated above, two films are formed in the same manner using identical assemblies on either side of the machine (not shown). The gelatin film or film formed from other compositions formed on one drum provides the shell material for one side of the capsule. The rotary dies are housed behind the yoke assembly. The films are threaded over the co-acting dies (not shown) into communication with each other. Pressure is applied to the dies to force them against each other. This force, in conjunction with heat from the wedge assembly, causes the two films of gelatin or other suitable film forming material to be sealed together and cut along the cavities on the dies to produce a semi-formed, empty capsule. In simultaneous action, pump assembly 5 held by base 8 measures and dispenses the fill material in hopper 10 (i.e., nutritionals, pharmaceuticals and the like) through the tubes into the injection wedge segment 2 and then into the semi-formed, empty capsule via injection ports in the fill material distribution device or wedge. The rotation of the dies continues the sealing and cutting process to form a complete filled capsule. Output shoots 12 receive the completed capsules.

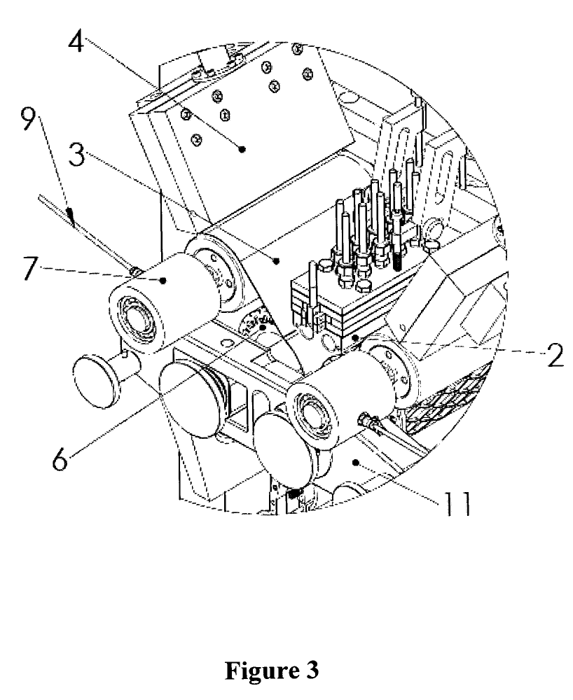

In further detail referring to FIG. 3, reference numeral 4 is the extrusion die/box from which film 3 is extruded directly into cooled guide and tension roller 7 which then passes directly into rotary die 6 for making the softgel capsules of the invention.

The process of the invention is carried out by first preparing a solution of the film forming polymer (i.e., gelatin or other suitable polymer composition for making capsules) and, if appropriate, further auxiliaries. The solids content of the solution is chosen so that the content of the film forming polymer is at least 45% by weight and up to 75% by weight, preferably 50 to 70% by weight, based on the total weight of the aqueous solution. The solution is brought before the extrusion to a temperature of about 45-65° C. The heated solution is then discharged through from the holding tank and pumped through tubing 15 and after extrusion, a film is produced.

Apparatuses suitable for carrying out the process are conventional extruders. Also suitable is any other apparatus which is designed for processing heated liquids and includes a pump or other conveying units in order to force the heated polymer-containing liquid under pressure through a suitable die device. It is possible to use for this purpose all conventional pumps and conveying units capable of pulsation-free conveying.

The preferred process of the invention is preferably carried out with an extruder. In principle, the conventional types of extruder known to the skilled worker are suitable for the process of the invention. These ordinarily comprise a housing, a drive unit and a plastifying or mixing unit composed of one or more rotating shafts provided with conveying or mixing elements (screws). The solution to be extruded can be produced using conventional extrusion technology such as a slot die, single-screw extruder, a twin-screw extruder or in multiple screw extruders.

The heated polymer solution is discharged as through a suitable die. Discharge is possible for example through a pipe die or, preferably, through a slot die. Slot dies for producing films are known per se. After leaving the slot die, the films are passed through cooled rollers 7 and solidified by cooling. This entails reducing the temperature of the extrudate by at least 10° C. in order to achieve solidification to films.

Before the processing in the encapsulation unit, the films obtained according to the invention and suitable as soft capsule shells can be moistened if desired with water or with water-miscible organic solvents or with mixtures of water and water-miscible solvents. Suitable water-miscible solvents are: glycerol, 1,2-propylene glycol, polyethylene glycol with molecular weights of between 250 and 600. This is particularly advisable when the film used for encapsulation is insufficiently soft and tacky and thus sealing is difficult. Superficial application of these substances softens the film and improves sealability. Application is possible by spraying on, roller application, brushing on or knife application.

The particular advantages of the described capsules and of the described process are that the processing times for producing the films are very short (only a few minutes) and the films comprise hardly any air bubbles. The short production time makes it possible to adapt the speed of film production to the speed of encapsulation. Film production and encapsulation thus take place in a completely continuous process. This is not possible by using the process of film casting from polymer solutions. In this case it is necessary for the polymer solution first to be prepared, applied by a spreader box into a casting drum and dried.

The process of the invention also makes it possible further to adjust the water content easily and individually virtually without any restriction due to high viscosities. It is thus possible to adjust very high solids contents. By contrast, knife application of films is possible only with low-viscosity solutions. The smaller amount of water which must be evaporated results in a considerably more favorable energy balance in the process of the invention.

The sealing can likewise take place at high speed very uniformly and reproducibly and without fissures or pores, and thus extremely few damaged capsules are rejected. In addition, the capsules are easy to dry, retain their shape and flexibility during this and are stable on storage.

Typical packaged materials are preferably pharmaceutical products such as solid and liquid active ingredients, but also vitamins, carotenoids, minerals, trace elements, food supplements, spices and sweeteners. The capsules can also be used for cosmetic active ingredients (personal care), such as, for example, hair and skin formulations, for oils, perfumes, bath additives or proteins.

Further possible examples of such packaged materials are cleaners, such as soaps, detergents, colorants and bleaches, agrochemicals such as fertilizers (or combinations thereof), crop protection agents such as herbicides, fungicides or pesticides, and seeds.

The apparatus and process of the invention provides the following advantages:

(1) Significant energy savings because no cooling is required for casting drums;

(2) Significant savings in gelatin consumption since one can retain the gelatin in the feeders when the apparatus is not use without having to disassemble the system for washing prior to restarting the system;

(3) Significant savings in lubricant use because there is no displacement by using guiding rollers for the gelatin film;

(4) The process temperature of less than 45° C. allows for an increase in shelf life of the gelatin, especially in preserving Bloom strength (160 at 180 Bloom);

(5) The design is much simpler and easier to operate;

(6) It requires less physical space;

(7) Lower cost; and

(8) It will allow for less water consumption in the gelatin formulation therefore providing less dry time for the capsules, less cross-linking and better stability of the product.

To facilitate the understanding of all the drawings Applicant provides a glossary of each element associated with all the figures:

1. Cooling water recirculation hose
2. Wedge segment
3. Gelatin film
4. Gel dispenser (extrusion box)

### 5. Medicine Dispenser Pump

6. Rotary (mold) dies
7. Cooling System and guide/tension roller

### 8. Medical Pump Base

### 9. Housing

### 10. Medicine Hopper

11. Rotary mold fastener
12. Capsule receiving and dispensing system
13. Tubing for dispensing medicine
14. Clamp coupling
15. Tubing through which melted gel is pumped through.

The contents of my copending non-provisional applications filed Jul. 18, 2011, and concurrently filed with this application and based on provisional applications No. 61/344,416 and 61/344,417 are incorporated by reference in their entirety as if they were individually denoted.

All patents, patent applications and publications cited in this application including all cited references in those applications and publications, are hereby incorporated by reference in their entirety for all purposes to the same extent as if each individual patent, patent application or publication were so individually denoted.

While the many embodiments of the invention have been disclosed above and include presently preferred embodiments, many other embodiments and variations are possible within the scope of the present disclosure and in the appended claims that follow. Accordingly, the details of the preferred embodiments and examples provided are not to be construed as limiting. It is to be understood that the terms used herein are merely descriptive rather than limiting and that various changes, numerous equivalents may be made without departing from the spirit or scope of the claimed invention.

What we claim is:

1. An apparatus for making softgel capsules comprising:
(a) means for pumping and providing a fluid film forming substance directly into two extrusion nozzle, said extrusion nozzles directly located so upon extruding a film said film goes directly into two cooling and tension rollers for transportation of said film to two rotary dies; and (b) an injection wedge disposed between and in communication with said rotary dies; and (c) a filling station.

2. A process for producing softgel capsules, comprising the steps of:
(a) softening or melting a suitable film forming composition;
(b) extruding said suitable film forming composition through two extrusion dies directly into two tension rollers;
(c) passing the extruded films over rotating dies;
(d) simultaneously forming, filling, heat-sealing and cutting capsules; and
(e) washing and drying said capsules.

3. An apparatus for forming softgel capsules comprising:
(a) pumping means for supplying at least one flowable mass which is formable into a sheet configuration;
(b) extruding means for forming two sheets from said flowable mass;
(c) means for forming filled capsules with said sheets;
(d) means for transferring said sheets from said sheet forming means to said capsule forming means;
(e) said capsule forming means comprising two rotary dies; means for dispensing a filler substance to at least one portion of one of said sheets prior to said portion exiting said encapsulation region where said filler substance is encapsulated between portions of said sheets with the proviso that said apparatus does include spreader boxes or casting drums.
